(19) United States
(12) Patent Application Publication
(10) Pub. No.: US 2026/0364499 A1
(43) Pub. Date: Nov. 19, 2026

(54) AIR FILTER WITH SUPPORT STRUCTURES THAT ENGAGE CENTRALLY ON A FLAT FILTER ELEMENT

(71) Applicant: MANN+HUMMEL GmbH, Ludwigsburg (DE)

(72) Inventors: Sören JURGENSON, Nordheim (DE); Wolfgang REISER, Ludwigsburg (DE); Markus SCHMIDL, Pilsting (DE); Ingo KOCH, Steinheim (DE); Daniel SCHMID, Sachsenheim (DE); Christoph WITTMERS, Bietigheim-Bissingen (DE); Pascal NEEF, Trossingen (DE); Fabian HASLER, Marklkofen (DE)

(21) Appl. No.: 19/656,232

(22) Filed: Apr. 23, 2026

Related U.S. Application Data
(63) Continuation of application No. PCT/EP2024/081713, filed on Nov. 8, 2024.

(30) Foreign Application Priority Data
Nov. 10, 2023 (DE) 10 2023 131 379.7

(51) Int. Cl. B01D 46/00; B01D 46/10; B01D 46/52; F02M 35/024

(52) U.S. Cl. CPC B01D 46/0005; B01D 46/10; B01D 46/521; B01D 2265/04; B01D 2271/027; B01D 2279/40; B01D 2279/60; F02M 35/02491

(57) ABSTRACT

An air filter has a housing top part and a housing bottom part. A flat filter element arranged in the housing has a filter medium body surrounded externally by a circumferentially extending seal. The filter medium body has a first side and a second side, facing away from each other and extending transversely to a main flow direction. A sealing body is arranged at the filter medium body inside of a region enclosed by the seal. The sealing body has a dome with a circumferentially enclosed hollow space projecting past the second side and having an open end facing the first side. The housing bottom part has a support finger engaging the dome from the first side and extending past the second side in a mounted state and supported at the sealing body. The housing top part has a support element supported at the sealing body in the mounted state.

### CROSS-REFERENCE TO RELATED APPLICATIONS

This application is a continuation application of international application No. PCT/EP2024/081713 having an international filing date of Nov. 8, 2024, and designating the United States, the international application claiming a priority date of Nov. 10, 2023, based on prior filed German patent application No. 10 2023 131 379.7, the entire contents of the aforesaid applications being incorporated herein by reference to the fullest extent permissible.

### BACKGROUND

The invention concerns an air filter including a housing with a housing top part and with a housing bottom part as well as including a flat filter element with a filter medium body and with a circumferentially extending seal externally surrounding the filter medium body, wherein the filter medium body includes a first side and a second side facing away from each other and extending transversely to a main flow direction, wherein a sealing body is arranged at the filter medium body inside of the region enclosed by the seal. The invention further concerns such a flat filter element for an air filter.

Such an air filter is disclosed in EP 3 103 543 A1.

Air filters with flat filter elements are used, for example, in motor vehicles as intake air filters for internal combustion engines or as cabin air filters. Typically, the flat filter elements are sealed by a circumferentially extending seal in relation to a housing, wherein the circumferentially extending seal effects at the same time a supporting action of the flat filter element at the housing. For example in case of large flat filter elements, undesirable deformations or vibrations of the flat filter element and/or of the housing may occur in operation.

The EP 3 103 543 A1 already mentioned above describes a filter element that includes a circumferentially extending seal element configured for separating a clean side from a raw side. The filter element forms an exchangeable filter insert part and includes at least one cutout which extends between the clean side and the raw side, wherein a plug-shaped damping element is received in the at least one cutout. A housing dome is integrally formed at the inner side of two housing parts, respectively, and is configured as one piece together with the respective housing part. A first housing dome is located at the inner side of the raw air side housing part and projects into the cutout provided at the filter element. An end face of the raw side housing dome contacts the damping element inside of the cutout. The second housing dome is located at the inner side of the clean air side housing part, wherein, in the mounting position, the two conically shaped housing domes are coaxially aligned relative to each other and the respective end faces of the housing domes are facing each other. The damping element is clamped between the end faces of the housing domes.

WO 2018/158387 A1 discloses a filter element for filtration of intake air in a motor vehicle, wherein the filter element includes a frame and wherein the filter element includes at least two filter media which are arranged adjacent to each other in the frame. The filter material of the first filter medium is different from the filter material of the second filter medium. The frame delimits at the rim the first filter medium and the second filter medium and separates these two filter media from each other by a center stay. The center stay of the frame may include a U-shaped cutout for receiving a housing projection of a housing pot. A housing cover may include a hold-down element by means of which it presses on a seal element of the filter element in the region of the center stay.

A filter disclosed in EP 1 144 083 B1 includes a filter insert which is arranged in a housing so as to be flowed through by intake air. For reinforcement, a cover of the housing includes a support at its center point which is configured of a hollow socket fastened in the housing body and a threaded socket fastened in the cover. These sockets are connected to each other by a connecting screw after the cover has been placed onto the housing body. In this context, the support passes through a cutout which is provided in the filter insert and sealed by an additional seal in relation to the support.

EP 3 297 745 B1 describes a filter element with a filter medium body, wherein, for supporting the filter element in a receiving filter housing, a support element is connected to the filter medium body which is located at the clean side of the filter medium body, wherein the support element is separated from the raw side by means of the material of the filter medium body. The support element at the filter medium body includes a convex outwardly curved outer side to be received in a concave inwardly curved end face of a counter support element at the filter housing.

A filter element disclosed in DE 10 2017 011 435 A1 includes a deformable carrier membrane which separates a clean side from a raw side and is a carrier of a first sensor part. In interaction with a housing-side second sensor part, a pressure sensor results which detects a deformation of the elastic carrier membrane.

It is an object of the invention to force a positionally correct installation of a centrally supported flat filter element.

### SUMMARY

This object is solved by an air filter, for example intake air filter for an internal combustion engine or cabin air filter for a motor vehicle, including a housing with a housing top part and with a housing bottom part as well as including a flat filter element with a filter medium body and with a circumferentially extending seal externally surrounding the filter medium body, wherein the filter medium body includes a first side and a second side which are facing away from each other and extend transversely to a main flow direction, wherein a sealing body is arranged at the filter medium body inside of the region enclosed by the seal,

wherein the sealing body forms a dome with a circumferentially enclosed hollow space open toward the first side and projecting past the second side,

wherein the housing bottom part includes a support finger which, in the mounted state, engages from the first side the dome of the sealing body and extends past the second side and is supported at the sealing body,

and wherein the housing top part includes a support element which is supported at the sealing body in a mounted state.

This object is further solved by a flat filter element, for example for an air filter according to the invention, including a filter medium body and a circumferentially extending seal which externally surrounds the filter medium body, wherein the filter medium body includes a first side and a second side which are facing away from each other and extend transversely to a main flow direction, wherein a sealing body is arranged at the filter medium body inside of the region enclosed by the seal, and wherein the sealing body forms a dome with a circumferentially enclosed hollow space open toward the first side and extending past the second side.

Preferred embodiments are disclosed in the following description and the accompanying drawings.

According to the invention, an air filter is provided. The air filter may be for example an intake air filter for an internal combustion engine or a cabin air filter for a motor vehicle.

The air filter includes a housing with a housing top part and with a housing bottom part. The terms housing bottom part and housing top part are used here independently of the installation position and serve primarily for differentiating the two housing parts. In general, the housing top part is arranged above the housing bottom part. However, it is also conceivable to arrange the housing bottom part above or adjacent to the housing top part. Slanted arrangements of the housing in space are also conceivable.

Furthermore, the air filter includes a flat filter element with a filter medium body and with a circumferentially extending seal. The seal surrounds the filter medium body externally. In the mounted state, the seal may seal the filter medium body in relation to the housing. In addition, the seal may seal the housing top part in relation to the housing bottom part.

The filter medium body includes a first side and a second side which are facing away from each other and which extend transversely to a main flow direction. The filter medium body may be flowed through from one side to the other side. Typically, the filter medium body may be flowed through from the first side to the second side; the first side may then also be referred to as an inflow side and the second side as an outflow side. However, it is also conceivable that the filter medium body may be flowed through from the second side to the first side; the second side may then be referred to as inflow side and the first side as an outflow side. The sides may be planar or stepped or undulated. Planar sides may extend parallel to each other or at a slant relative to each other.

The filter medium body may include a folded filter medium. For example, the filter medium body may be formed with a single folded bellows or a plurality of folded bellows.

A sealing body is arranged at the filter medium body inside of the region enclosed by the seal. Typically, the sealing body is spaced apart from the circumferentially extending seal. In principle, the sealing body is inherently air tight. Typically, the sealing body is joined seal-tightly to the filter medium body.

The sealing body may comprise, and for example be comprised of, soft or hard plastic material. For example, the sealing body may be comprised of the same material as the circumferentially extending seal. For example, the sealing body and/or the seal may be comprised of polyurethane, for example polyurethane foam.

According to the invention, the sealing body forms a dome with a circumferentially enclosed hollow space which is open toward the first side and projects past the second side. In other words, a dome-shaped section of the sealing body surrounds the hollow space in circumferential direction and toward the second side, wherein the hollow space includes an opening toward the first side. Along the main flow direction, the dome and the hollow space project past the second side. For example, the sections of the dome which project past the second side are closed. In regard to the description of the sealing body, directional specifications such as radial, axial, or circumferential in direction relate to an axis through the sealing body which is parallel to the main flow direction.

Further according to the invention, the housing bottom part includes a support finger which, in the mounted state, engages from the first side the dome of the sealing body and extends beyond the second side and is supported at the sealing body. The housing top part includes a support element which, in the mounted state, is supported at the sealing body. The flat filter element is thus supported from both sides at the housing. In addition, the two housing parts stabilize each other by contacting the sealing body.

Since the hollow space which is defined by the dome projects past the second side and the support finger also projects past the second side, the first side of the filter medium body is forced to always face the housing bottom part and the second side always the housing top part. Therefore, a positionally correct installation is ensured. The support finger which projects past the second side forces in addition the use of flat filter elements which include a matching sealing body. The installation of unsuitable flat filter elements may be prevented in this way. During mounting, a pre-centering action of the flat filter element at the housing bottom part may be effected additionally due to the far projecting support finger. This may simplify the alignment of the circumferentially extending seal at a seal seat of the housing bottom part.

For example, the support finger and the support element are hollow and open toward an exterior of the housing. Manipulations at the support finger or support element, for example, a later trimming in order to enable mounting of conventional flat filter elements with a uniform thickness, would therefore open up the housing toward the exterior and make it unusable.

For example, the sealing body is permanently, in other words fixedly, connected to the filter medium body. In this way, it is avoided that the sealing body accidentally becomes detached when exchanging of the flat filter element. The sealing body, for example, may be integrally formed at the filter medium body, for example cast on or foamed on or glued thereto.

As an alternative, the sealing body may be detachably arranged at the filter medium body. This may simplify the manufacture. The sealing body, for example, may be inserted into a passage of the filter medium body.

For example, the filter medium body may include a circumferentially closed passage which extends from the first side to the second side, wherein the sealing body closes the passage. The passage is arranged inside of the region which is enclosed by the seal. For example, the passage is surrounded in circumferential direction by the filter medium of a single folded bellows. Such a passage enables positioning of the sealing body centrally at the flat filter element and thus a particularly effective stabilization thereof as well as of the housing.

The filter medium body may include a folded bellows in which the passage is embodied. For example, the passage may be surrounded in circumferential direction by the filter medium of a single folded bellows. The passage may be sealed by at least one glue bead. For example, the at least one glue bead may close seal-tightly fold end face edges of the folded bellows in a region surrounding the passage. For example, the passage may be sealed by at least two glue beads which extend transversely to the fold edges. Such a sealing action is economically producible. The glue beads sealing the passage may extend continuously across the entire length of the folded bellows. This simplifies the manufacture further because the application of the glue onto the not yet folded filter medium must not be interrupted. As an alternative, the glue beads sealing the passage may extend, beginning at the passage, in directions which are facing away from each other and extend only partially in direction toward rims of the folded bellows which are positioned opposite each other. This has the advantage that a reduced material quantity is required for the glue beads.

Glue beads may be provided also at outer sides of the filter medium body for sealing its folds. Glue beads for sealing the outer sides are also continuously formed in principle.

The at least one glue bead may include an adhesive or glue. For example, the at least one glue bead may include a hot melt. Herein, the term glue bead is to be understood therefore as adhesive beads or hot melt beads as well as also actual beads of glue.

The seal may be arranged at the second side of the filter medium body. This makes it possible to produce the sealing body and the seal in one working step and to connect them to the filter medium body. For example, a common casting mold for the seal and the sealing body may be used.

The dome of the sealing body may include at least one bulge in radially outward direction. The bulge expands the hollow space radially outwardly. In the region of the bulge an outer surface of the dome may project outwardly.

The support finger may include a radially outwardly protruding rib which engages the bulge in the mounted state. For example, precisely one bulge and precisely one rib may be provided. Due to the engagement of the rib in the bulge, a defined rotational alignment of the flat filter element may be ensured even when the sealing body is arranged centrally at the flat filter element.

The dome of the sealing body may include a plurality of, for example precisely three, bulges in radially outward direction. This may simplify the manufacture and mounting of the sealing body.

The support finger may include a plurality, for example precisely three, radially outwardly protruding ribs which, in the mounted state, each engage one of the bulges, respectively. The plurality of bulges and ribs may be arranged rotationally symmetrically or asymmetrically. An uneven number of bulges and ribs effects a defined rotational alignment of a rectangular flat filter element, even in case of a rotational symmetrical arrangement.

The sealing body may include at least one axial depression. The depression forms a recess in the sealing body. Open sides of the depression and of the dome or of the hollow space are facing away from each other in principle. In other words, the recess which is formed by the depression is open toward the second side.

The support element may include at least one projection which engages the depression in the mounted state. Due to the engagement of the projection in the depression, a defined rotational alignment of the flat filter element may be ensured even when the sealing body is arranged centrally at the flat filter element.

The sealing body may include a plurality of, for example precisely three, axial depressions. This may simplify the manufacture and mounting of the sealing body.

The support element may include a plurality of, for example precisely three, projections which each engage one of the depressions, respectively, in the mounted state. The plurality of depressions and projections may be arranged rotationally symmetrically or asymmetrically. An uneven number of depressions and projections effects a defined alignment of a rectangular flat filter element, even in case of a rotationally symmetrical arrangement.

The projections and ribs as well as the bulges and depressions may alternatingly follow each other in circumferential direction. In this way, a compact sealing body may be obtained. The bulges and depressions as well as the projections and ribs may stabilize each other mutually.

The sealing body may include a flange at the open end of the dome. The flange may extend parallel to the first side.

The support finger may include a shoulder which contacts the flange in the mounted state. In this way, a support action of the filter medium body perpendicularly to the plane of its main expansion may be realized.

For example, the flange delimits the at least one depression toward the first side. In the mounted state, the flange may be clamped between the at least one projection of the support element and the shoulder of the support finger. The filter medium body is thus supported with form fit in both directions transversely to the plane of its main expansion. In addition, the support finger and the support element support each other by means of the flange so that housing walls from which they project are stabilized relative to each other.

The at least one projection of the support element and the support finger may overlap each other along the main flow direction in the mounted state. This effects a support action of the two housing parts at each other acting parallel to the plane of the main expansion of the flat filter element. In addition, vibrations of the filter medium body in the plane of its main expansion may be particularly effectively suppressed.

The dome may include an apex which is contacted, on the one hand, by the support finger of the housing bottom part and, on the other hand, by the support element of the housing top part, for example by an end face. The sealing body is thus clamped in the region of the apex between the support finger and the support element. The filter medium body is thus supported with form fit in both directions transverse to the plane of its main expansion. In addition, the support finger and the support element support each other in the region of the apex so that housing walls from which they project are stabilized relative to each other. The apex is the region of the dome which projects farthest past the second side.

The sealing body may have a central recess; an end face of the support element is resting at its bottom in the mounted state. A protruding bead rim may surround the recess. The bead rim may extend annularly closed around the recess or include at least one recessed section. For example, two recessed sections may be provided symmetrically to the central recess in the bead rim. Due to the engagement of the support element in the recess, the filter medium body may be supported with form fit in the plane of its main expansion. At the same time, the support element may be designed particularly simply and thus may be manufactured economically.

Inside of the dome, the sealing body may include a protrusion which protrudes toward the first side. In this embodiment, the hollow space enclosed by the dome may be at least substantially annular as a whole. An apex surface of the dome, which projects farthest in main flow direction past the second side, may surround the protrusion in an annular shape. For example when a (external) bead rim of the dome includes at least one recessed section, the (internal) apex surface may have corresponding interruptions. The apex surface then surrounds the protrusion in at least one ring segment.

At its axial end facing the sealing body, the support finger may include a central hollow. The protrusion engages the central hollow in the mounted state. In this way, a form fit fixation of the filter element at the housing bottom part may be achieved. Due to the protrusion, a sufficiently large wall thickness of the sealing body may be additionally achieved when the latter includes a central recess.

In the mounted state, the protrusion may contact a bottom side of the hollow. This enables a support of the filter element at the housing bottom part transversely to the plane of the main expansion of the filter medium body.

The support finger may include a rim at its end which is facing the sealing body. The rim may surround the hollow in a closed annular shape. As an alternative, the rim may include at least one interruption, for example two interruptions which are opposite each other in relation to the hollow. For example, the rim in the mounted state contacts an apex surface of the dome. In this way, a support of the filter element in the plane of its main expansion and transversely thereto may be achieved.

For example, the sealing body is arranged eccentrically at the filter medium body. In this way, independent of the outer contour of the flat filter element, a defined rotational position of the flat filter element in relation to an axis which is parallel to the main flow direction may be enforced.

At the filter medium body, inside of the region surrounded by the seal, a plurality of sealing bodies may be arranged, wherein the sealing bodies each form a dome with a circumferentially enclosed hollow space which is open toward the first side and projects past the second side.

The housing bottom part may include a plurality of support fingers which, in the mounted state, engage the dome of one of the sealing bodies from the first side, respectively, and extend past the second side and are supported at the respective sealing body. The housing top part may include a plurality of support elements which, in the mounted state, are supported at one of the sealing bodies, respectively. In this way, a particularly great stabilization effect may be achieved.

The plurality of sealing bodies, support fingers and/or support elements may each include further features as described above. For example, the plurality of sealing bodies, support fingers and/or support elements are of the same configuration, respectively.

The scope of the present invention also encompasses a flat filter element, for example for an air filter according to the invention as described above. The flat filter element includes a filter medium body and a circumferentially extending seal which surrounds the filter medium body externally. The filter medium body includes a first side and a second side which are facing away from each other and which extend transversely to a main flow direction. At the filter medium body, a sealing body is arranged inside of the region enclosed by the seal. The sealing body forms a dome with a circumferentially enclosed hollow space which is open toward the first side and projects past the second side. The flat filter element may include any of the further features described above.

### BRIEF DESCRIPTION OF THE DRAWINGS

Further features and advantages of the invention result from the following detailed description of embodiments of the invention with the aid of the drawing figures showing details according to the invention. The aforementioned and still further explained features may be realized individually by themselves or a plurality combined in any expedient combinations in variants of the invention. The features depicted in the drawings are illustrated such that the particularities according to the invention may be made clearly visible.

FIG. 1 shows an air filter according to the invention comprising a flat filter element according to the invention in a schematic section view.

FIG. 2 shows the air filter of FIG. 1 in a schematic exploded view looking onto an outflow side of the flat filter element.

FIG. 3 shows the air filter of FIG. 1 in a schematic exploded view looking onto an inflow side of the flat filter element.

FIG. 4 shows an enlarged detail of FIG. 1 in a region of a sealing body of the flat filter element which is held between a support finger and a support element.

FIG. 5 shows an inflow side view of the sealing body of the flat filter element of FIG. 1.

FIG. 6 shows an outflow side view of the sealing body of the flat filter element of FIG. 1.

FIG. 7 shows a further flat filter element according to the invention comprising two sealing bodies for an air filter according to the invention in a schematic perspective view.

FIG. 8 shows a schematic cross section through one of the sealing bodies of the flat filter element of FIG. 7.

FIG. 9 shows a support element of a housing for the flat filter element of FIG. 7 in a schematic perspective view.

FIG. 10 shows a schematic of a further air filter according to the invention.

FIG. 11 shows a detail of a further air filter according to the invention in the region of a sealing body of a flat filter element according to the invention in a schematic section view.

### DETAILED DESCRIPTION

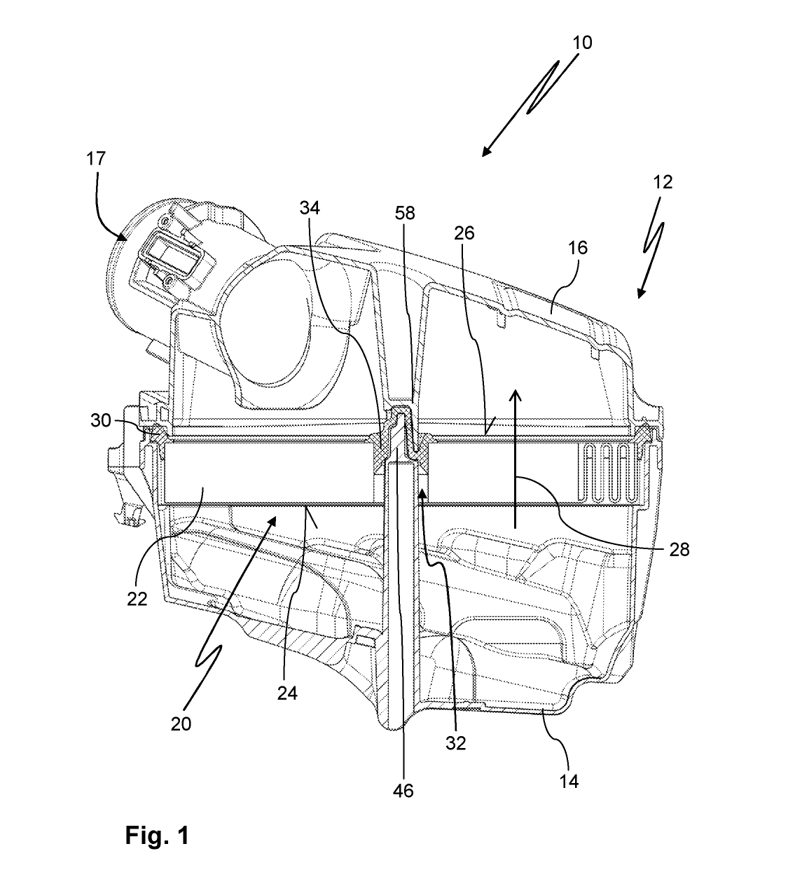

FIGS. 1, 2 and 3, show an air filter 10. The air filter 10 comprises a housing 12 with a housing bottom part 14 and with a housing top part 16. The housing bottom part 14 and the housing top part 16 are detachably fastenable to each other. At the housing bottom part 14, a raw air inlet 15 for air to be filtered is provided. At the housing top part 16, a clean air outlet 17 for filtered air is formed.

The air filter 10 comprises furthermore a flat filter element 20 that is exchangeably arranged in the housing 12. A filter medium body 22 of the flat filter element 20 is formed as a folded bellows from filter medium, for example, filter paper, folded in a zigzag shape. The filter medium body 22 may be flowed through from a first side 24 to a second side 26 along a main flow direction 28. The first side 24 forms in other words a raw side inflow side, the second side 26 forms a clean side outflow side. In the illustrated embodiment, the first and the second sides 24, 26 extend respectively in a plane and parallel to each other.

A circumferentially extending seal 30 is attached externally at the filter medium body 22. The seal 30 may be comprised of polyurethane and, for example, may be foamed onto the filter medium body 22. Presently, the seal 30 is arranged so as to adjoin the second side 26. In the mounted state, see FIG. 1, the circumferentially extending seal 30 seals the flat filter element 20 in relation to the housing 12 so that a raw side, here correlated with the housing bottom part 14, is separated from a clean side, here correlated with the housing top part 16. Furthermore, the seal 30 seals the housing bottom part 14 and the housing top part 16 relative to each other. For this purpose, the seal 30 is compressed between the two housing parts 14, 16.

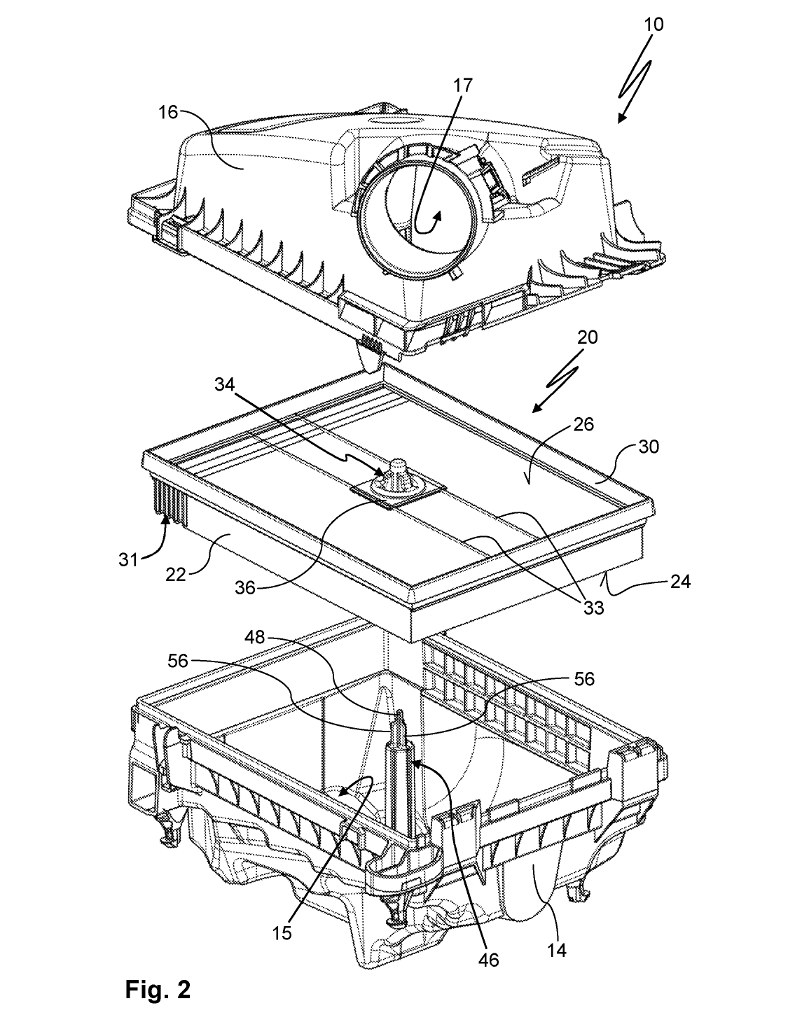

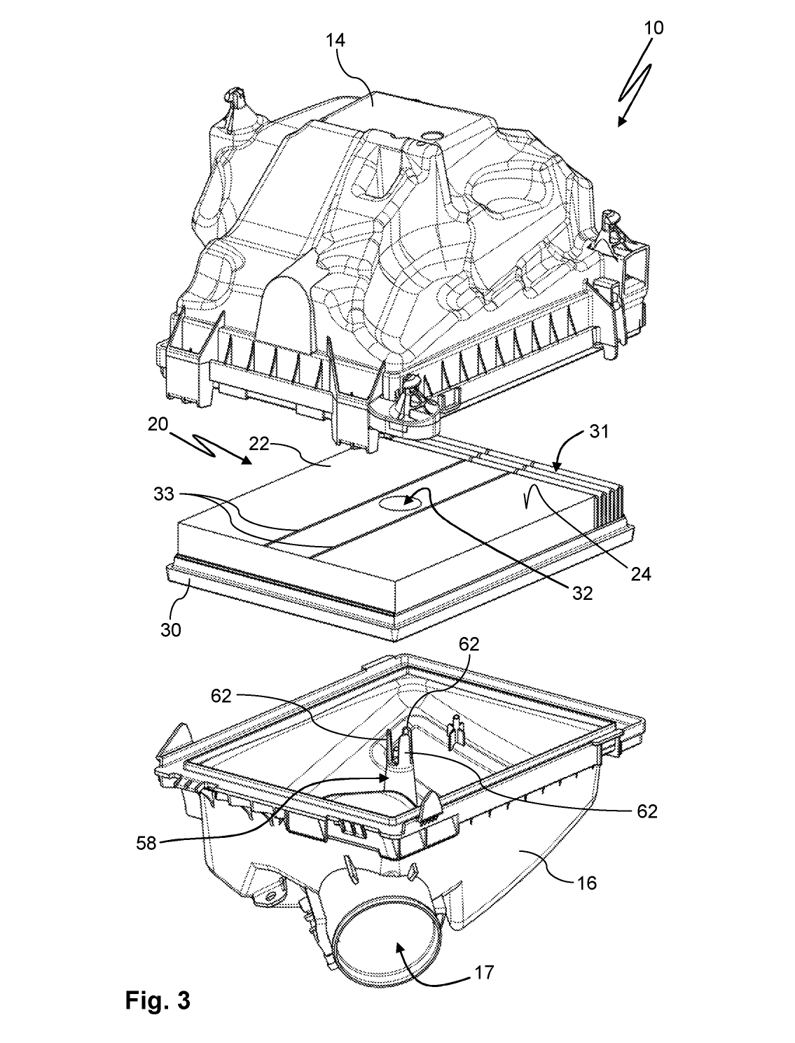

In the interior of the filter medium body 22, a passage 32 is formed which extends from the first side 24 to the second side 26. The passage 32 is circular cylindrical embodied here. Circumferentially, the passage 32 is surrounded by the filter medium body 22. Folds of the filter medium body 22 are sealed in relation to the passage 32 by glue beads 33 which extend transversely to fold edges 31 of the filter medium body 22, see FIG. 2 and FIG. 3. Here, the glue beads 33 extend across the entire length of the filter medium body 22.

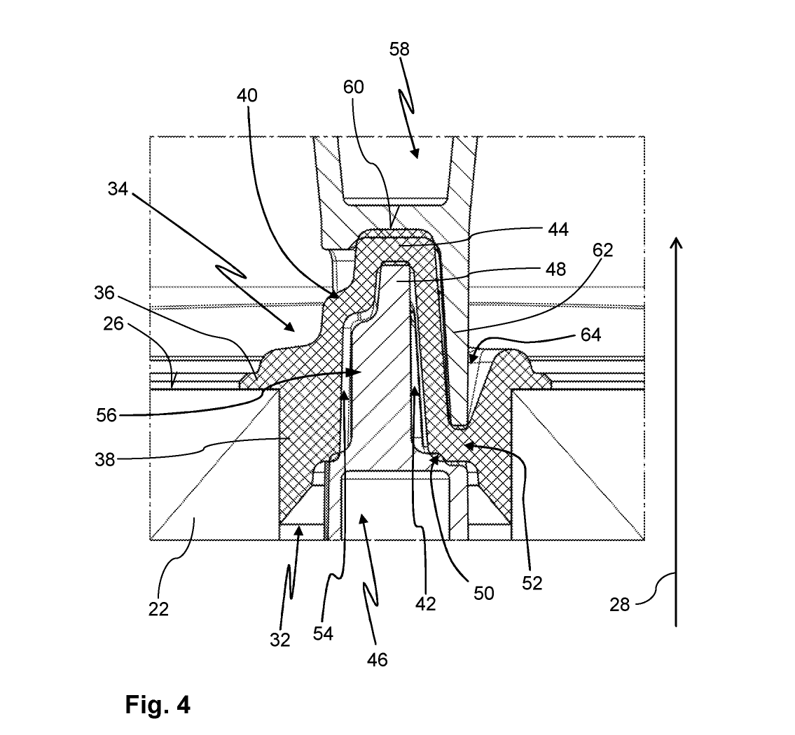

The sealing body 34 closes the passage 32, see also FIG. 4. The sealing body 34 may be comprised of polyurethane and, for example, foamed onto the filter medium body 22. In this way, a non-detachable connection of the sealing body 34 to the filter medium body 22 is obtained. Here, the sealing body 34 as a whole is of a one piece configuration.

The sealing body 34 is seated with a collar 36 on the second side 26 of the filter medium body 22, see FIG. 2 and FIG. 4. A shaft section 38 of the sealing body 34 extends into the passage 32, see for example FIG. 4.

The sealing body 34 comprises a dome 40 which projects past the second side 26 of the filter medium body 22, see for example FIG. 4. The dome 40 encloses a hollow space 42 which is open toward the first side 24. The dome 40 rises so far past the second side 26 that also the hollow space 42 - when viewed along the main flow direction 28 - is arranged partially above the second side 26. An apex 44 of the dome 40 delimits the hollow space 42 in axial direction (parallel to the main flow direction 28).

By means of the sealing body 34, the flat filter element 20 is supported at the housing 12 inside of the region enclosed by the seal 30. The support action is realized in relation to the housing bottom part 14 as well as in relation to the housing top part 16. Thus, the two housing parts 14, 16 are also supported at each other through the sealing body 34.

The housing bottom part 14 comprises a support finger 46 which engages from the first side 24 the hollow space 42 of the sealing body 34. The support finger 46 passes through the passage 32 parallel to the main flow direction 28 so that its axial end 48 is located beyond the second side 26 of the filter medium body 22. The support finger 46 is resting, on the one hand, with its axial end 48 at the inner side of the apex 44 of the dome 40. On the other hand, a shoulder 50 of the support finger 46 is resting against a flange 52 of the sealing body 34. The flange 52 is located inside of the passage 32.

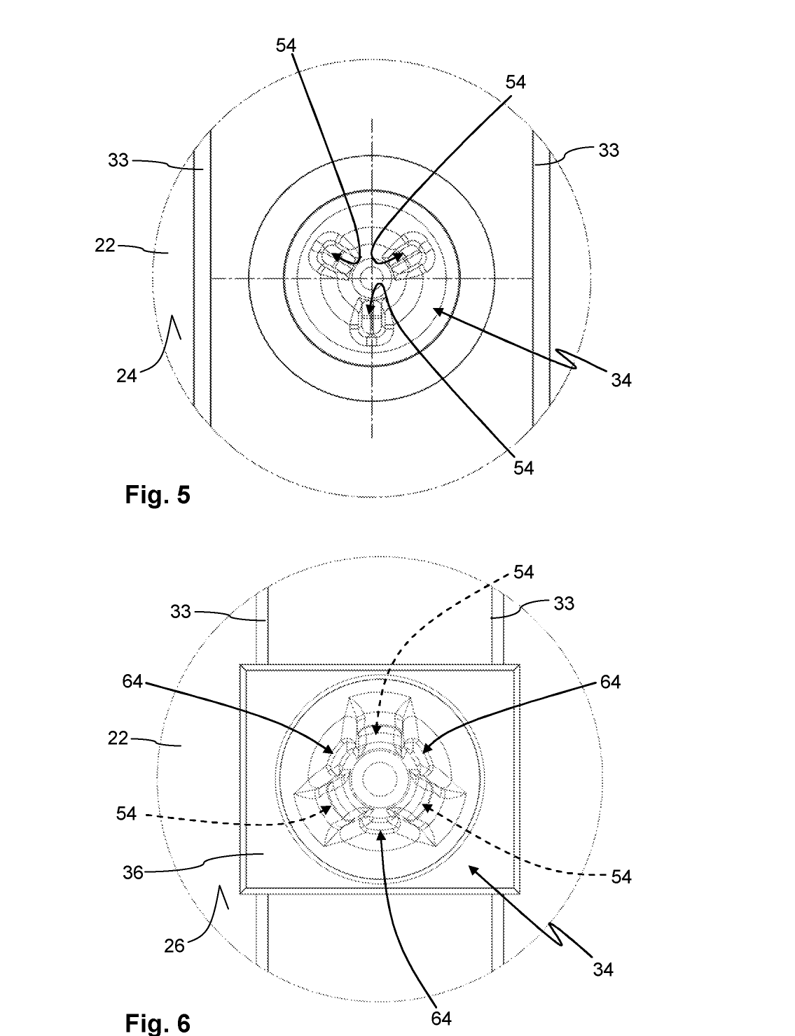

In this embodiment, the dome 40 of the sealing body 34 is provided with three bulges 54 which expand the hollow space 42 in regions radially outwardly, see also FIG. 5. In the region of the bulges 54, the dome 40 bulges outwardly, see FIG. 4 and FIG. 6. Presently, the bulges 54 are distributed uniformly around the circumference of the dome 40. Between the shoulder 50 and its axial end 48, the support finger 46 comprises three radially outwardly extending ribs 56 (see for example FIG. 2), which each engage one of the bulges 54 (see for example FIG. 1 and FIG. 4).

The housing top part 16 is supported by a support element 58 at the sealing body 34. On the one hand, an end face 60 of the support element 58 is contacting externally the apex 44 of the dome 40 (see for example FIG. 4). The sealing body 34 is thus clamped in the region of the apex 44 between the support finger 46 and the support element 58. On the other hand, the flange 52 of the sealing body 34 is clamped between three projections 62 (see also FIG. 3) of the support element 58 and the shoulder 50 of the support finger 46 (see again for example FIG. 4).

In order to enable an engagement of the projections 62 all the way to the flange 52, the sealing body 34 comprises three depressions 64. In the region of the depressions 64, the sealing body 34 is recessed away from its collar 36 below the second side 26. In relation to the first side 24, the depressions 64 are delimited by the flange 52. In circumferential direction, the depressions 64 are arranged between the bulges 54, see FIG. 6.

In a mounted state, the projections 62 of the support element 58 and the ribs 56 of the support finger 46 overlap each other along the main flow direction 28, see FIG. 4. In circumferential direction, the ribs 56 are located in the region of the gaps between the projections 62.

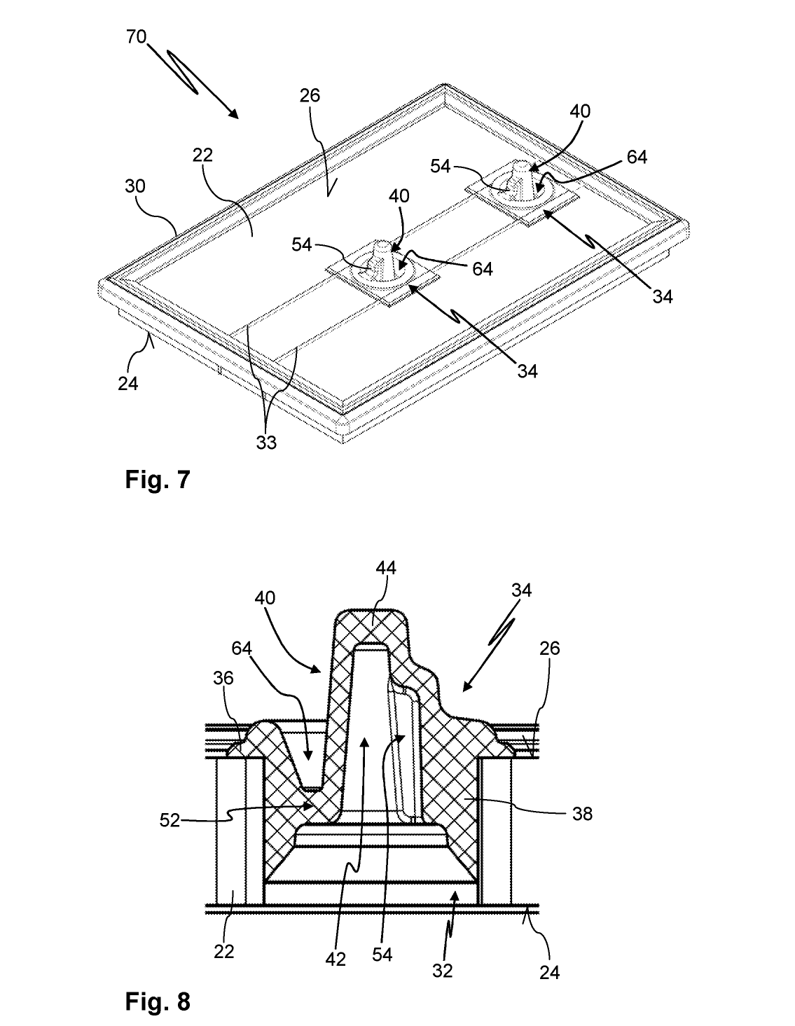

FIG. 7 shows a further flat filter element 70 for an air filter. The flat filter element 70 of FIG. 7 corresponds in its basic configuration to the above-described flat filter element 20 shown in FIGS. 1 to 6. Therefore, reference is being had to the above description; primarily the differences will be explained in the following.

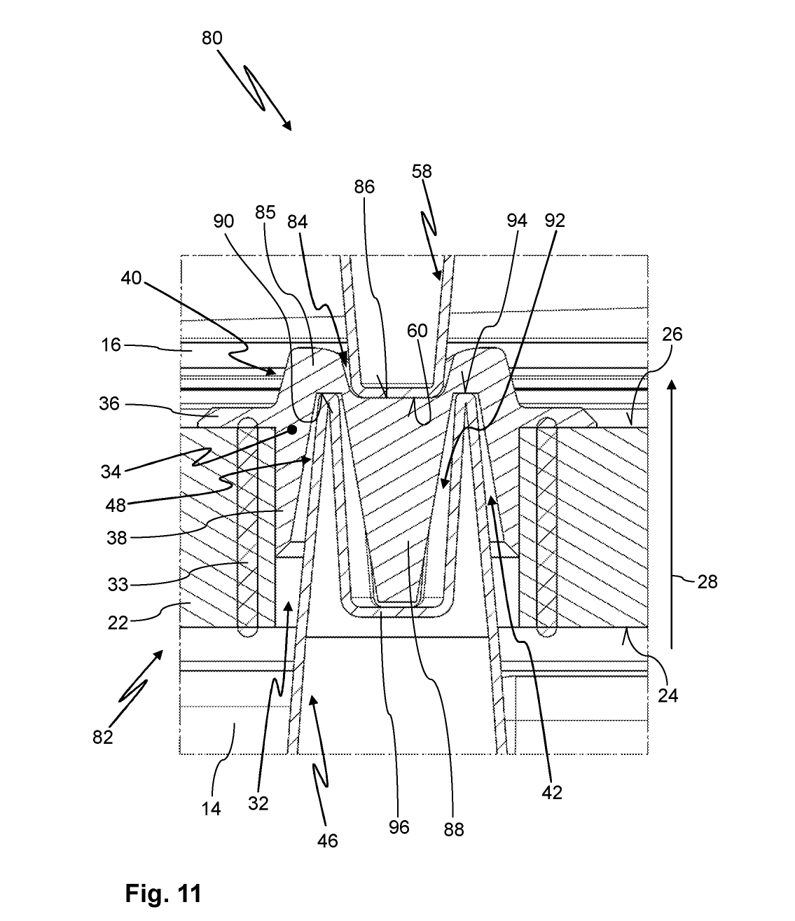

In the flat filter element 70, two sealing bodies 34 are arranged at a passage 32, respectively. Both sealing bodies 34 are arranged off-center in longitudinal direction (transversely to the fold edges of a folded bellows forming the filter medium body 22) as well as in the transverse direction (parallel to the fold edges). A housing 12 of an air filter 72 with the flat filter element 70 comprises correspondingly two support fingers 46 at the housing bottom part 14 and two support elements 58 at the housing top part 16, see the abstract illustration in FIG. 10.

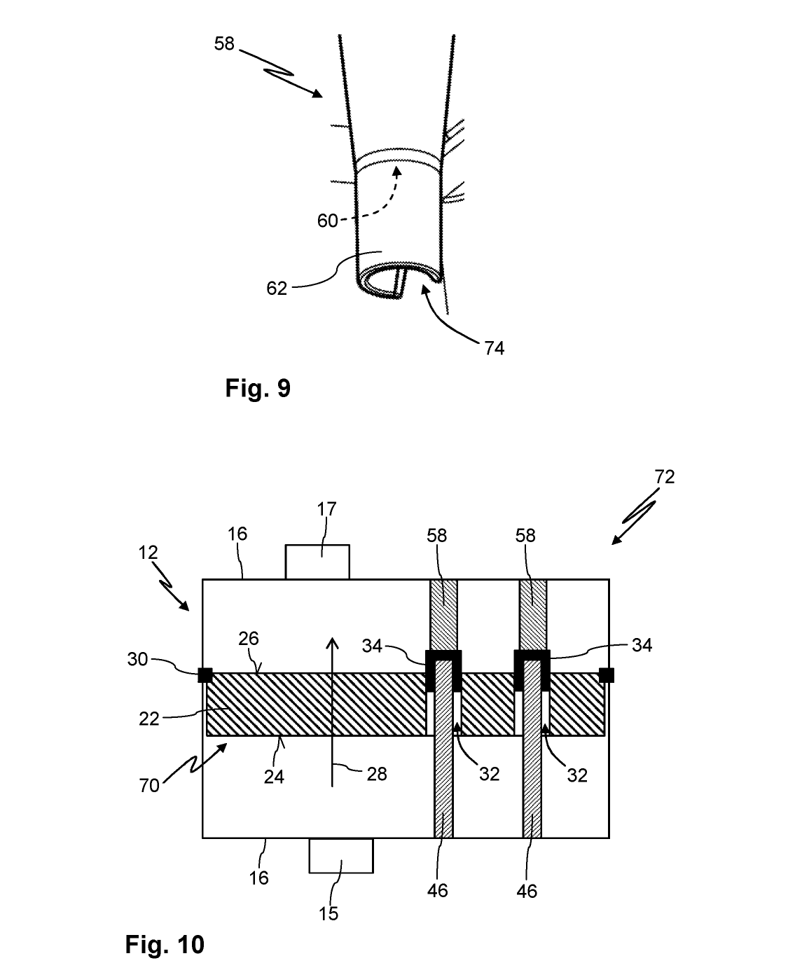

In the flat filter element 70, the domes 40 of the sealing bodies 34 comprise a single radial bulge 54, respectively. A single axial depression 64 extends across more than half, here more than two thirds, of the circumference of the respective dome 40. For example, the depression 64 extends at the side of the dome 40 of the respective sealing body 34 which is opposite the bulge 54, see also FIG. 8. The two support elements 58 of the housing top part 16 each comprise a single projection 62 surrounding the dome 40 around more than 180° in circumferential direction, see FIG. 9. A rib of a support finger 46 is aligned in the mounted state with a cutout 74 of the projection 62 (not illustrated in detail).

FIG. 11 shows a detail of a further air filter element 80 with a flat filter element 82. The air filter 80 and the flat filter element 82 of FIG. 11 correspond in basic construction to the above-described air filter 10 or flat filter element 20 illustrated in FIGS. 1 to 6. Therefore, reference is being had to the above description; primarily the differences will be explained in the following.

A sealing body 34 which closes a passage 32 in a filter medium body 22 of the flat filter element 82 comprises a central recess 84 at its dome 40, the latter projecting past a second side 26 of the filter medium body 22 at least in regions. The recess 84 is formed at the outer side of the dome 40 which is facing away from the hollow space 42 enclosed by the dome 40. The recess 84 may be surrounded by a bead rim 85 which may comprise for example two recessed sections which are oppositely positioned relative to each other in relation to the central recess 84 (not visible in the section plane of FIG. 11).

A support element 58 of a housing top part 16 extends into the recess 84. An end face 60 of the support element 58 rests against a bottom 86 of the recess 84.

Inside of the hollow space 42 of the dome 40, a protrusion 88 is formed. The protrusion 88 and the recess 84 are arranged opposite each other at the dome 40 in relation to the main flow direction 28. The protrusion 88 is pointing with its free end toward the first side 24 of the filter medium body 22. In this embodiment, the hollow space 42 surrounds the projection 88 within the dome 40 in circumferential direction.

In axial direction (parallel to the main flow direction 28), the hollow space 42 is delimited by an apex surface 90. When viewed in the main flow direction 28, the apex surface 90 beyond the second side 26 surrounds the base of the protrusion 88, at least about a circumferential region. The apex surface 90 may be formed for example by ring segments between which, corresponding to the recessed sections in the bead rim 85, axial retractions may be formed (not visible in the section plane of FIG. 11).

A support finger 46 of a housing bottom part 14 comprises a hollow 92 at its free axial end 48. The hollow 92 is surrounded by a rim 94 at its open end. The rim 94 may be designed substantially in a ring shape, for example wherein, corresponding to the axial retractions between the ring segments of the apex surface 90, interruptions may be provided between circumferentially extending sections of the rim 94 (not visible in the section plane of FIG. 11). A closed bottom side 96 of the hollow 92 is recessed in relation to the rim 94. Presently, the bottom side 96 is of a planar configuration.

The protrusion 88 contacts with its free end the bottom side 96 of the hollow 92. At the same time, the free rim 94 of the support finger 46 contacts the apex surface 90 of the dome 40. Thus, the sealing body 34 is clamped between the support finger 46 and the support element 58 which, as described above, contacts the sealing body 34 from the other side. Thus, the filter medium body 22 is supported in relation to the two housing parts 14, 16, for example in direction of and opposite to the main flow direction 28 and in the plane of the main expansion of the filter medium body 22 which is perpendicular thereto.

As in the above-described embodiments (see FIGS. 1 to 6 and 7 to 10), the support finger 46 engages the sealing body 34 from the first side 24 of the filter medium body 22. Here, for example the rim 94 at the axial end 48 of the support finger 46 projects past the second side 26 of the filter medium body 22.

In summary, the invention concerns a flat filter element and an air filter. A filter medium body of the flat filter element is enclosed circumferentially by a seal. Inside of the region enclosed by the seal, the filter medium of the filter medium body comprises a passage. In the region of the passage, the filter medium body is closed by a sealing body. The sealing body prevents a transfer of unfiltered air from the raw side to the clean side. The sealing body bulges in a dome shape. In a mounted state, a support finger of a first housing part engages from a first side the sealing body and projects completely through the filter medium body parallel to the main flow direction so that the support finger protrudes at the second side of the filter medium body. The dome-shaped region of the sealing body spans the projecting support finger. The sealing body is received between the support finger of the first housing part and a support element of a second housing part. The support finger and the support element effect a two-sided support of the filter medium body by means of the sealing body.

### REFERENCE CHARACTERS

air filter 10

housing 12

housing bottom part 14

raw air inlet 15

housing top part 16

clean air outlet 17

flat filter element 20

filter medium body 22

first side 24

second side 26

main flow direction 28

seal 30

fold edges 31

passage 32

glue beads 33

sealing body 34

collar 36

shaft section 38

dome 40

hollow space 42

apex 44

support finger 46

axial end 48

shoulder 50

flange 52

bulge 54

rib 56

support element 58

end face 60

projection 62

depression 64

flat filter element 70

air filter 72

cutout 74

air filter 80

flat filter element 82

recess 84

bead rim 85

bottom 86

protrusion 88

apex surface 90

hollow 92

rim 94

bottom side 96

1. An air filter comprising:
a housing comprising a housing top part and a housing bottom part;
a flat filter element comprising a filter medium body and a circumferentially extending seal externally surrounding the filter medium body;
wherein the filter medium body comprises a first side and a second side, wherein the first side and the second side face away from each other and extend transversely to a main flow direction;
a sealing body arranged at the filter medium body inside of a region enclosed by the circumferentially extending seal;
wherein the sealing body comprises a dome comprising a circumferentially enclosed hollow space, wherein the circumferentially enclosed hollow space projects past the second side and comprises an open end facing the first side;
wherein the housing bottom part comprises a support finger, wherein the support finger, in a mounted state of the air filter, engages the dome of the sealing body from the first side and extends past the second side, wherein the support finger is supported at the sealing body;
wherein the housing top part comprises a support element which is supported at the sealing body in the mounted state.

2. The air filter according to claim 1, wherein the sealing body is connected permanently to the filter medium body.

3. The air filter according to claim 1, wherein the sealing body is detachably arranged at the filter medium body.

4. The air filter according to claim 1, wherein the filter medium body comprises a circumferentially closed passage extending from the first side to the second side, and wherein the sealing body closes the circumferentially closed passage.

5. The air filter according to claim 4, wherein the filter medium body comprises a folded bellows, wherein the circumferentially closed passage is formed in the folded bellows, and wherein the circumferentially closed passage is sealed by one or more glue beads.

6. The air filter according to claim 5, wherein two of the glue beads are provided to seal the circumferentially closed passage, wherein the two glue beads extend transversely to fold edges of the folded bellows.

7. The air filter according to claim 1, wherein the circumferentially extending seal is arranged at the second side of the filter medium body.

8. The air filter according to claim 1, wherein the dome of the sealing body comprises at least one bulge extending in a radially outward direction, and wherein the support finger comprises a radially outwardly protruding rib engaging the at least one bulge in the mounted state.

9. The air filter according to claim 1, wherein the dome of the sealing body comprises a plurality of bulges extending in a radially outward direction, and wherein the support finger comprises a plurality of radially outwardly protruding ribs each engaging one of the plurality of bulges in the mounted state.

10. The air filter according to claim 1, wherein the sealing body comprises one or more axial depressions and wherein the support element comprises one or more projections each engaging one of the one or more axial depressions in the mounted state.

11. The air filter according to claim 1, wherein the sealing body comprises axial depressions and wherein the support element comprises projections each engaging one of the axial depressions in the mounted state, wherein the dome of the sealing body comprises bulges extending in a radially outward direction and wherein the support finger comprises radially outwardly protruding ribs each engaging one of the bulges in the mounted state, wherein the bulges and the axial depressions alternatingly follow each other in a circumferential direction of the sealing body, and wherein the projections and the ribs alternatingly follow each other in the circumferential direction of the sealing body.

12. The air filter according to claim 1, wherein the sealing body comprises a flange at the open end of the circumferentially enclosed hollow space of the dome and wherein the support finger comprises a shoulder contacting the flange in the mounted state.

13. The air filter according to claim 12, wherein the sealing body comprises one or more axial depressions and wherein the support element comprises one or more projections each engaging one of the one or more axial depressions in the mounted state, wherein the flange delimits the one or more axial depressions toward the first side, and wherein the flange is clamped between the one or more projections of the support element and the shoulder of the support finger in the mounted state.

14. The air filter according to claim 1, wherein the sealing body comprises one or more axial depressions and wherein the support element comprises one or more projections each engaging one of the one or more axial depressions in the mounted state, wherein the one or more projections and the support finger overlap each other along the main flow direction in the mounted state.

15. The air filter according to claim 1, wherein the dome comprises an apex, wherein the support finger of the housing bottom part and the support element of the housing top part rest at the apex of the dome.

16. The air filter according to claim 1, wherein the sealing body comprises a central recess and wherein an end face of the support element rests at a bottom of the central recess in the mounted state.

17. The air filter according to claim 1, wherein the sealing body comprises a protrusion inside of the dome, wherein the protrusion protrudes toward the first side, wherein the support finger at an axial end thereof facing the sealing body comprises a central hollow, wherein the protrusion engages the central hollow in the mounted state.

18. The air filter according to claim 17, wherein the support finger comprises a rim at the axial end facing the sealing body, wherein the rim contacts an apex surface of the dome in the mounted state.

19. The air filter according to claim 1, wherein a plurality of the sealing body are arranged at the filter medium body inside of the region enclosed by the seal, wherein the housing bottom part comprises a plurality of the support finger each engaging in the mounted state the dome of one of the plurality of the sealing bodies from the first side, wherein the housing top part comprises a plurality of the support element each supported at one of the plurality of the sealing bodies in the mounted state.

20. A flat filter element for use in an air filter according to claim 1, the flat filter element comprising:
the filter medium body having the circumferentially extending seal externally surrounding the filter medium body;
wherein the filter medium body comprises the first side and the second side, wherein the first side and the second side face away from each other and extend transversely to the main flow direction;
the sealing body arranged at the filter medium body inside of the region enclosed by the circumferentially extending seal;
wherein the sealing body comprises the dome comprising the circumferentially enclosed hollow space, wherein the circumferentially enclosed hollow space projects past the second side and comprises the open end facing the first side.
